(19) United States
(12) Patent Application Publication
(10) Pub. No.: US 2007/0006749 A1
(43) Pub. Date: Jan. 11, 2007

(54) Cylinder for flexographic printing, with angular position control device

(76) Inventors: Felip Ferrer Cadillach, Riudellots De La Selva (ES); Jordi Sahun Peres, Riudellots De La Selva (ES)

Correspondence Address: RATNERPRESTIA, P O BOX 980, VALLEY FORGE, PA, 19482-0980, US

(21) Appl. No.: 10/548,524

(22) PCT Filed: Mar. 16, 2004
(86) PCT No.: PCT/ES04/00119

§ 371 Date: Sep. 9, 2005

(30) Foreign Application Priority Data
Mar. 17, 2003 (ES) U200300661

(51) Int. Cl. B41F 5/00

(52) U.S. Cl. 101/216

(57) ABSTRACT

The invention relates to a machine roller for flexographic printing, comprising an angular position control device. The inventive roller (1) is of the type that is connected to an actuation assembly (2) by means of a coupling (3) between one end (4a) of a shaft (4) belonging to the roller (1) and one end of an output shaft (5) belonging to the actuation assembly (2). The above-mentioned angular control device comprises an angular position sensor (6) which is disposed coaxially to the aforementioned shaft (4) of the roller (1) between the coupling and an adjacent end (1a) of the roller (1).

### FIELD OF THE INVENTION

This invention relates to a cylinder for flexographic printing in a flexographic machine with an angular position control device constituted by a sensor located on the cylinder, in order to notify any deviation of said cylinder and, by means of a control device, carry out the necessary adjustments when activating the driving unit.

### PRIOR ART

The proposed cylinder is of the type that is connected to a driving unit via a connection between one end of a shaft of said cylinder and one end of an output shaft of said driving unit, and where said angular control device includes an angular position sensor.

Utility model ES-A-2160424 describes the arrangement of one or more angular position sensors and its use thereof in a positioning method. It shows the possibility of including one of these sensors in the driving unit and another in the functional part, for example a printing machine cylinder, but always at the ends thereof. At no point does it suggest including a connection between the electric motor and the functional part, and consequently it does not consider the problems arising therefrom when reading the angular position.

Therefore, it is desirable to offer an alternative for those cases where the cylinder is connected to the driving unit by a connection, in order to offer the most accurate reading possible of the angular position of the cylinder, without this reading being affected by interferences caused by motor and connection frequencies, or cylinder frequencies being perceived incorrectly, if the reading is taken far from the load, in the traditional fashion, in other words, directly on the motor.

The object of this invention is to provide a machinery cylinder for flexographic printing according to the desired characteristics mentioned above, in other words, with an as accurate as possible angular position reading, which is achieved by positioning the angular position sensor directly on the cylinder, in particular at the end thereof nearest the connection.

### SUMMARY OF THE INVENTION

The machinery cylinder for flexographic printing with angular position control device, according to this invention, consists of a cylinder of the type that is connected to a driving unit via a connection between one end of a shaft of said cylinder and one end of an output shaft of said driving unit, and where said angular control device includes an angular position sensor. The cylinder is characterised in that said angular position sensor is located coaxially with respect to said cylinder shaft and placed between the connection and one adjacent end of the cylinder.

The main advantages that this cylinder provides with respect to the state of the art is that, when using a direct angular position reading of said cylinder, said reading is much more accurate, whereby it is possible to obtain an improved, simpler angular position control method, which makes the use of servomotors unnecessary, and as a very interesting alternative asynchronous motors can be offered, since this proposal makes the obtained unit considerably cheaper.

Other characteristics of the invention will appear clearer from the following description of an embodiment illustrated in the attached drawings and which is to be considered as an illustrative, non-limiting example.

### BRIEF DESCRIPTION OF THE DRAWINGS

There follows an explanation of an embodiment, with reference to the attached drawings, in which:

FIG. 1 is a perspective view of part of a cylinder connected to a driving unit, and showing a housing of an angular position sensor.

FIG. 2 is a cross section along a central longitudinal plane of FIG. 1, where part of said cylinder, part of said driving unit, a connection, and said angular position sensor can be seen.

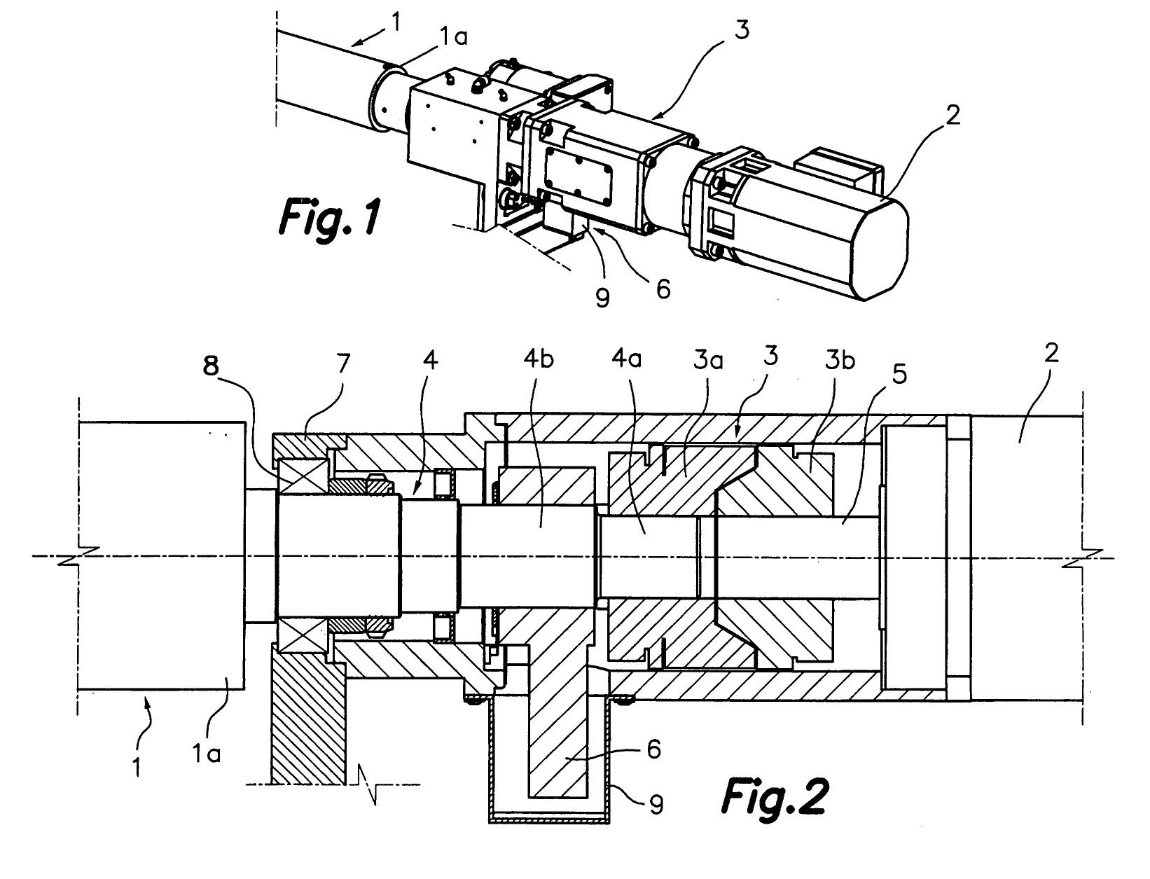

### DETAILED DESCRIPTION OF AN EMBODIMENT

As shown in these drawings, machinery cylinder 1 for flexographic printing with angular control device, which is mounted by means of bearings 8 on a support 7, is connected to a driving unit 2 by means of a connection 3, divided into two parts, one part 3a attached to one end 4a of a shaft 4 of said cylinder 1 and another part 3b attached to one end of an output shaft 5 of said driving unit 2. Said angular control device includes an angular position sensor 6, made up of a central rotor (not shown), connected over an intermediate part 4b to said end 4a of shaft 4 of cylinder 1 and a peripheral capturing part (not shown in detail) attached to a support of said shaft 4, covered by a housing 9, that can be seen in both drawings. Said sensor 6 is located coaxially with respect to shaft 4 of cylinder 1, between connection 3 and one adjacent end 1 a of cylinder 1. Driving unit 2 can include a motor with or without a reducing stage, and this motor can be asynchronous, for the reasons explained above.

1. A cylinder for flexographic printing with angular position control device, said cylinder being of the type that is connected to a driving unit via a connection between one end of a shaft of said cylinder and one end of an output shaft of said driving unit, and said angular position control device including an angular position sensor, wherein said angular position sensor is located coaxially with respect to said shaft of cylinder and placed between connection and one adjacent end of cylinder.

2. The cylinder, according to claim 1, wherein the angular position sensor comprises a central rotor, connected over an intermediate portion to said end of shaft of cylinder and a peripheral capturing part attached to a support of said shaft.

3. The cylinder, according to claim 1, wherein said connection is divided into two parts, one part attached to one end of shaft of cylinder and another part attached to one end of said output shaft of driving unit.

4. The cylinder, according to claim 1, wherein said driving unit comprises an asynchronous motor.

5. The cylinder, according to claim 1, wherein said driving unit comprises a servomotor.
